(19) United States
(12) Patent Application Publication
(10) Pub. No.: US 2026/0070227 A1
(43) Pub. Date: Mar. 12, 2026

(54) Novel Personal Rifle Robotic Station

(71) Applicant: Oren Aharon, Haifa (IL)

(72) Inventor: Oren Aharon, Haifa (IL)

(21) Appl. No.: 18/811,834

(22) Filed: Aug. 22, 2024

(51) Int. Cl. B25J 11/00; B25J 9/00; B25J 9/16; F41G 5/06; F41G 11/00

(52) U.S. Cl. CPC B25J 11/002; B25J 9/0009; B25J 9/1679; F41G 5/06; F41G 11/00

(57) ABSTRACT

A novel personal rifle robotic station is disclosed, designed to upgrade standard personal rifles through an external motorized attachment. This innovation provides robotic assistance for precise aiming, targeting, and remote firing. Unlike existing solutions that are often fully integrated, expensive, and cumbersome, this system transforms a conventional rifle into an automated firing station. The external attachment allows for precise control of the rifle's orientation, reducing the margin of error and enabling a single operator to remotely manage multiple systems simultaneously. In special configurations, the attachment can be folder to become a part of the rifle's stock.

### BACKGROUND OF THE INVENTION

The present invention relates to a personal rifle robotic station, designed to significantly enhance the usability of personal rifle systems by introducing motorization and remote control features. This innovation provides unprecedented precision, safety, versatility, and remote operation capabilities to this niche. Existing solutions in the market typically consist of fully integrated robotic systems that function as specialized firearm stations. In contrast, our invention aims to upgrade existing firearms, enabling their transformation into a robotic station as needed. Key features enabled by our technology include:
1. Robotic Assistance
2. Target Acquisition and Tracking
3. Remote Operation

The invention focuses on the remote control of a rifle's line of sight. The rifle is stabilized by a stationary point at the front, such as a bipod, allowing rotary movement, while a motorized system at the rear adjusts the rifle's line of sight based on external input. Three specific configurations will be disclosed:
1. A CNC motorized XYZ device with a gripper attached to the buttstock that moves the rifle's line of sight according to inputs in the XYZ directions.
2. A configuration based on a hexapod for achieving the required rifle pointing.
3. A configuration for similar usage replacing the rifle with a handgun.

For aiming purposes, a camera-based rifle scope will be used capable to deliver the image to a remote-control position where the operator will activate the system according to the provided information by said camera.

### SUMMARY

XYZ gantry consists of a movable 3-axis perpendicular to each other to manipulate its head in three directions. By manipulation the system can provide a spherical trace needed to move the rifle stock and provide an aiming capability to the device. The system allows for precise, automated aiming towards a specific target and it's implemented in our system for remote controlling a rifle.

Key Components and Operation:

Said XYZ gantry moves along linear rails or guideways, which are mounted on the base of the machine. Bearings or linear guides allow smooth, precise movement. XYZ direction perpendicular to each other.

Motors and Drives are stepper or servo motors which generate the movement along each axis. a dedicated controller and computer interface is the brain of the system, receiving an interpreting instruction from a computer which is translated into precise movement of the gantry. The target where to be directed is provided by a camera like scope mounted on top of the rifle. The camera line of sight, is calibrated to represent the shooting direction.

In our application the process starts with target acquisition provided by camera and operator. A computer using a language capable to control the XYZ directions will dictate the XYZ values to create the right aiming angle of present invention.

In another configuration, a hexapod is used to control the line of sight of the rifle. A hexapod is a type of parallel robotic mechanism that typically consists of six linear actuators (legs) connected to a common platform. The term “hexapod” literally means “six legs,” and these legs can be individually extended or retracted to move and tilt the platform in six degrees of freedom: three translational (X, Y, Z) and three rotational (pitch, roll, yaw).

Key Components and Operation:
1. Base Platform: The hexapod is anchored to a stable base, which provides the foundation for the movement of the platform above.
2. Movable Platform: This is the platform that supports the object being manipulated—in your case, the rifle. The platform can be moved in various directions and orientations by adjusting the lengths of the six legs.
3. Linear Actuators (Legs): These are the six adjustable-length components that connect the base platform to the movable platform. Each leg can extend or contract, causing the movable platform to change position and orientation.
4. Joints: The legs are connected to both the base and movable platforms using spherical or universal joints, allowing for the necessary range of motion.
5. Control System: The hexapod is controlled by a computer or microcontroller that sends commands to the actuators, specifying how much each leg should extend or retract. By carefully coordinating the movements of the legs, the system can precisely position and orient the platform.

How It Works:

Rotation (Pitch, Roll, Yaw): By differentially adjusting the lengths of the legs, the platform can be tilted around its central axes. For instance, to achieve a pitch motion (tilting forward or backward), the legs on one side are extended while the legs on the opposite side are retracted.

The rifle by definition is made to be handled by a human being using one hand in the front of the rifle and the second aiming point at its rear part usually the buttstock. In our automatization effort we rely upon s bipod to replace the front hand via a spherical bearing and the rear part is manipulated by a motorized system. We present such a motorized system based on CNC-like gantry system or hexapod device.

To summarize, a robotic rifle station for upgrading a standard personal rifle, comprises of an external motorized attachment configured to be mounted onto the rifle, a control system capable of adjusting the rifle's line of sight by manipulating the orientation of the rifle, a stationary support point, configured to stabilize the rifle at a front portion, a motorized system attached to a rear portion of the rifle, capable of rotating the rifle based on input from the control system, and wherein the control system enables remote operation of the rifle for precise aiming and targeting. The personal rifle robotic station is activated by a CNC motorized XYZ device with a gripper attached to the rifle's buttstock, wherein the XYZ device is configured to move the rifle's line of sight according to inputs along XYZ directions. Said personal rifle robotic station has a different activation possibility based on a hexapod mechanism configured to adjust the rifle's line of sight, wherein the hexapod provides six degrees of freedom for precise positioning and orientation. The personal rifle robotic station, wherein the external motorized attachment is foldable and configured to transform into a part of the rifle's stock for ease of transport. Moreover, the personal rifle robotic station is controlled by a system which includes a camera-based rifle scope configured to capture the rifle's line of sight and provide visual data to a remote operator, and a computer interface that processes the visual data and generates commands for adjusting the rifle's orientation. The personal rifle robotic station activated by a hexapod mechanism comprises of a base platform anchored to a stable surface, a movable platform supporting the rifle, wherein the movable platform is connected to the base platform by six linear actuators, and a spherical or universal joints connecting the linear actuators to the base and movable platforms, allowing the rifle to be aimed in various directions. Furthermore, the personal rifle robotic station, based on CNC XYZ device operates along linear rails mounted on a base, and the control system includes stepper or servo motors for precise movement along each axis. The personal rifle robotic station, wherein the control system is configured to allow a single operator to remotely manage multiple rifle systems simultaneously. The personal rifle robotic station, wherein the control system is capable of target acquisition and tracking based on inputs from the camera-based rifle scope. A method of enhancing a standard personal rifle with robotic capabilities, comprising attaching an external motorized system to the rifle, stabilizing the rifle using a stationary front support, adjusting the rifle's line of sight through motorized manipulation at the rear portion of the rifle, and remotely controlling the rifle's orientation and firing mechanism using a control system. The method includes utilization of a CNC motorized XYZ device to manipulate the rifle's line of sight in three-dimensional space based on external inputs, or utilizes a hexapod mechanism to adjust the rifle's line of sight by manipulating the position and orientation of the rifle in six degrees of freedom. The method enables the external motorized system to be foldable and can be transformed into a part of the rifle's stock for ease of carry and deployment. The method further comprises a camera-based rifle scope to capture and transmit visual data to a remote control position for precise aiming and firing decisions.

### BRIEF DESCRIPTION OF THE DRAWINGS

FIG. 1 is a 3-D representation of first embodiment showing an XYZ CNC type of gantry activator for weapon aiming.

FIG. 2 is a 3-D representation where the gantry device is folded for easy carry transformed into a part of buttstock.

FIG. 3 is a 3-D representation where said gantry XYZ activator is replaced with hexapod device.

FIG. 4 is a 3-D representation where the hexapod is used to aim a handgun from remote.

### DETAILED DESCRIPTION OF THE DRAWINGS

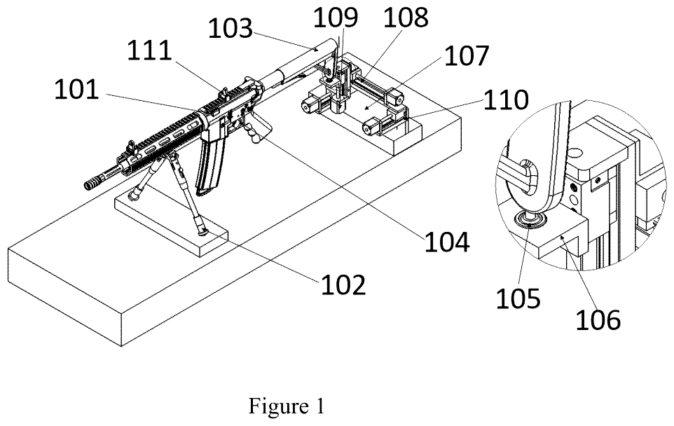

FIG. 1 illustrates an embodiment of a personal rifle robotic station designed to enhance the usability of a personal rifle through motorized aiming capabilities. The setup includes a standard personal rifle labeled as 101, a stock bipod with an integrated spherical bearing for rotation labeled as 102, and a buttstock labeled as 103. A remote operating trigger is denoted as 104. The buttstock is connected to the driving motors via a spherical bearing or a similar mechanism, labeled as 105, and is supported by a mechanical device with an integrated strain gauge, labeled as 106. The proposed XYZ activation device, labeled as 107, consists of three perpendicular linear motors in a gantry configuration: the X-axis is driven by linear motor 110, the Y-axis by 108, and the Z-axis by 109. Controllers allow a remote user to receive information from a video camera, labeled as 111, to facilitate target acquisition, aiming, and firing.

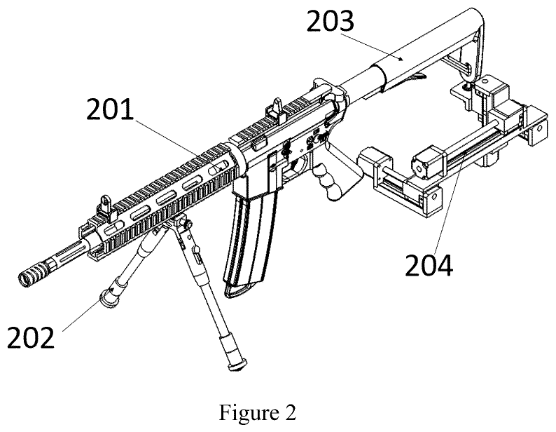

FIG. 2 depicts the previous configuration with the XYZ device, now labeled as 204, rotated so that its Y-axis is parallel to the buttstock, enabling easier hand carriage of the entire system. As shown in the previous figure, this configuration includes the personal rifle labeled as 201, bipod labeled as 202, and buttstock labeled as 203.

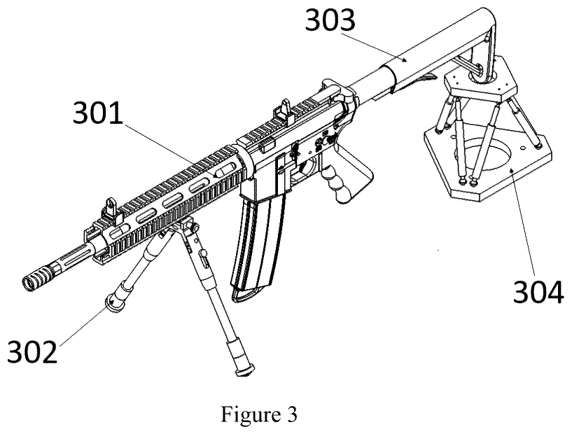

FIG. 3 presents another configuration where the motorized line manipulator is attached to the buttstock using a standard mechanical setup, specifically a hexapod, labeled as 304. This hexapod enables the buttstock, labeled as 303, to move in six degrees of freedom, aligning the rifle, labeled as 301, according to user inputs. As in the previous figures, the front of the rifle rests on a bipod, labeled as 302.

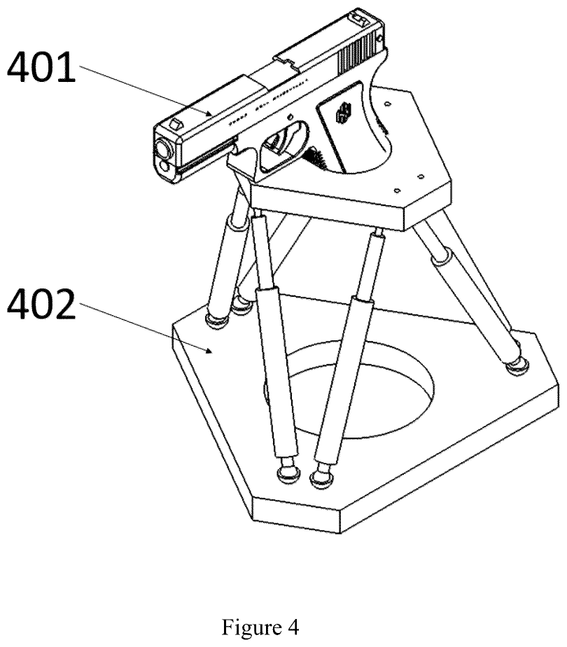

FIG. 4 shows yet another configuration where the personal rifle is replaced with a personal handgun. The handgun is labeled as 401, and the hexapod is labeled as 402.

1. A personal rifle robotic station for upgrading a standard personal rifle, comprising:
an external motorized attachment configured to be mounted onto the rifle;
a control system capable of adjusting the rifle's line of sight by manipulating the orientation of the rifle;
a stationary support point, configured to stabilize the rifle at a front portion;
a motorized system attached to a rear portion of the rifle, capable of rotating the rifle based on input from the control system; and
wherein the control system enables remote operation of the rifle for precise aiming and targeting.

2. The personal rifle robotic station of claim 1, further comprising:
a CNC motorized XYZ device with a gripper attached to the rifle's buttstock, wherein the XYZ device is configured to move the rifle's line of sight according to inputs along XYZ directions.

3. The personal rifle robotic station of claim 1, further comprising:
a hexapod mechanism configured to adjust the rifle's line of sight, wherein the hexapod provides six degrees of freedom for precise positioning and orientation.

4. The personal rifle robotic station of claim 1, wherein the external motorized attachment is foldable and configured to transform into a part of the rifle's stock for ease of transport.

5. The personal rifle robotic station of claim 1, wherein the control system includes:
a camera-based rifle scope configured to capture the rifle's line of sight and provide visual data to a remote operator; and
a computer interface that processes the visual data and generates commands for adjusting the rifle's orientation.

6. The personal rifle robotic station of claim 3, wherein the hexapod mechanism comprises:
a base platform anchored to a stable surface;
a movable platform supporting the rifle, wherein the movable platform is connected to the base platform by six linear actuators; and
spherical or universal joints connecting the linear actuators to the base and movable platforms, allowing the rifle to be aimed in various directions.

7. The personal rifle robotic station of claim 2, wherein the CNC motorized XYZ device operates along linear rails mounted on a base, and the control system includes stepper or servo motors for precise movement along each axis.

8. The personal rifle robotic station of claim 1, wherein the control system is configured to allow a single operator to remotely manage multiple rifle systems simultaneously.

9. The personal rifle robotic station of claim 1, wherein the control system is capable of target acquisition and tracking based on inputs from the camera-based rifle scope.

10. A method of enhancing a standard personal rifle with robotic capabilities, comprising:
attaching an external motorized system to the rifle;
stabilizing the rifle using a stationary front support;
adjusting the rifle's line of sight through motorized manipulation at the rear portion of the rifle; and
remotely controlling the rifle's orientation and firing mechanism using a control system.

11. The method of claim 10, further comprising:
utilizing a CNC motorized XYZ device to manipulate the rifle's line of sight in three-dimensional space based on external inputs.

12. The method of claim 10, further comprising:
utilizing a hexapod mechanism to adjust the rifle's line of sight by manipulating the position and orientation of the rifle in six degrees of freedom.

13. The method of claim 10, wherein the external motorized system is foldable and can be transformed into a part of the rifle's stock for ease of carry and deployment.

14. The method of claim 10, further comprising:
using a camera-based rifle scope to capture and transmit visual data to a remote control position for precise aiming and firing decisions.
